(19) United States
(12) Patent Application Publication
(10) Pub. No.: US 2011/0239291 A1
(43) Pub. Date: Sep. 29, 2011

(54) Detecting and Thwarting Browser-Based Network Intrusion Attacks For Intellectual Property Misappropriation System and Method

(75) Inventor: SCOTT SOTKA, SAN JOSE, CA (US)

(73) Assignee: BARRACUDA NETWORKS, INC., CAMPBELL, CA (US)

(21) Appl. No.: 12/732,189

(22) Filed: Mar. 26, 2010

(51) Int. Cl. G06F 21/00

(52) U.S. Cl. 726/14; 726/11

(57) ABSTRACT

Detecting and thwarting browser-based network intrusion attacks for intellectual property misappropriation is provided by enabling a local machine to direct retrieval of resources using uniform resource identifiers to a browser operating within a virtual machine whose internet protocol address is within a range external to a trusted network sub-circuit. Such a virtual machine is constrained by not having access to the Active Director Server of the trusted network. Such a virtual machine is constrained by not having access to other resources of the trusted network. Such a virtual machine is constrained by a monitor application which terminates the virtual machine if characteristics of intrusion or network attack are observed within the virtual machine.

### BACKGROUND

It is a fact universally acknowledged that allowing untrusted software to execute on a computer may enable a vulnerability exploit by which malicious software can obtain access privileges and theft of passwords or other confidential information. Yet social engineering cleverness continues to induce even well trained users within a trusted network to read mail, open files, and visit websites which are infected with just such malicious software. It is not possible to prevent just one of a large number of student—or employees from visiting a malicious website at all times using a browser with an unknown vulnerability.

It is known in the art that the Dynamic Host Configuration Protocol (DHCP) is a computer networking protocol used by hosts (DHCP clients) to retrieve Internet Protocol (IP) address assignments and other configuration information.

DHCP uses a client-server architecture. The client sends a broadcast request for configuration information. The DHCP server receives the request and responds with configuration information from its configuration database.

It is known in the art that a DHCP server responds to a request from a machine in a network by assigning an internet protocol address out of a range of internet protocol addresses.

It is known in the art that a domain name system (DNS) server responds to a request from a machine in a network by looking up an internet protocol address for a domain name.

It is known in the art that passwords and accounts stored in an Active Directory server may be attacked by a malicious program designed to exploit a browser vulnerability and obtain supervisory privileges over an operating system controlling a local machine. It is known that an Active Directory has been compromised which contained account access information for administrative accounts (superusers) by inserting malware through a browser vulnerability.

While many methods are available for securing data within trusted networks, protected by firewalls, and passwords, even very experienced professional are seduced by clever social engineering to access email, websites, and social networking resources which are transmitted by malefactors. A common method is to induce them to access a webpage or read an email containing a malicious script which is designed to exploit a vulnerability in a browser, an email client, or an operating system.

It is the objective of the present invention disclosure to reduce the negative consequences of such a misjudgment with only minor inconvenience and acceptably slight inefficiency and higher overhead.

### BRIEF DESCRIPTION OF DRAWINGS

FIG. 1 is a conventional server comprising a exemplary processor configured to perform instructions encoded on machine readable media.

FIG. 2 is a system data flow diagram of the logical connection of a local machine.

FIG. 3 is a hierarchical block diagram of software controlling a local machine.

### SUMMARY OF THE INVENTION

The present invention comprises a system comprising a layered network of trusted and untrusted subnets isolated by a firewall from the Internet. The inner trusted network comprises Local DNS servers, Active Directory Servers, DHCP Servers and a plurality of local machines whose IP addresses are registered with DHCP as participating in the Active Directory and on the trusted network.

Within such a network comprising a trusted subnet and an untrusted subnet managed by at least one Dynamic Host Configuration Protocol (DHCP) server, is at least one:
local machine configured with a first operating system and a first internet protocol address obtained from the DHCP server which is within the range of trusted sub-network IP addresses;
the local machine further configured with a virtual machine process which presents a virtual processor configured with a second operating system and a second internet protocol (IP) address assigned by the DHCP server which said IP address is within the range of un-trusted sub-network IP addresses;
the local machine further configured with a browser operating within the virtual machine process under the second operating system and communicatively coupled to the public Internet via a firewall; and
the local machine further configured with a monitoring application under the first operating system adapted to observe network activity within the virtual machine process, and terminate the virtual machine process under conditions consistent with malicious intrusion.

The local machines in addition to providing a user with access to applications and objects on the trusted sub-network, also comprises a processor configured to operate a virtual machine process configured to have no privileges within the trusted network. When said virtual machine process requests assignment of an IP address from the DHCP server it receives an IP address which does not have access to the Active Director Server but does have access to the external public Internet.

The present invention is a method for operating a processor configured to operate on a trusted subnet of a network by transferring every request for a resource on the Internet to a virtual machine configured to run an operating system and a browser, said virtual machine configured with an Internet Protocol address that is external to the trusted subnet of the network.

### DETAILED DISCLOSURE OF EMBODIMENTS OF THE INVENTION

In various embodiments of the invention, it comprises at least one of the following processes:
a monitoring application for configuring a processor to detect if the virtual machine process attempts to change its network privileges;
a monitoring application for configuring a processor to detect if the virtual machine process attempts to change its IP address;
a monitoring application for configuring a processor to detect if the virtual machine process attempts to operate network services instructions;
a monitoring application for configuring a processor to copy and archive the virtual machine process; and
a monitoring application for configuring a processor to terminate a virtual machine process on the condition that the virtual machine is attempting to change its access privileges.

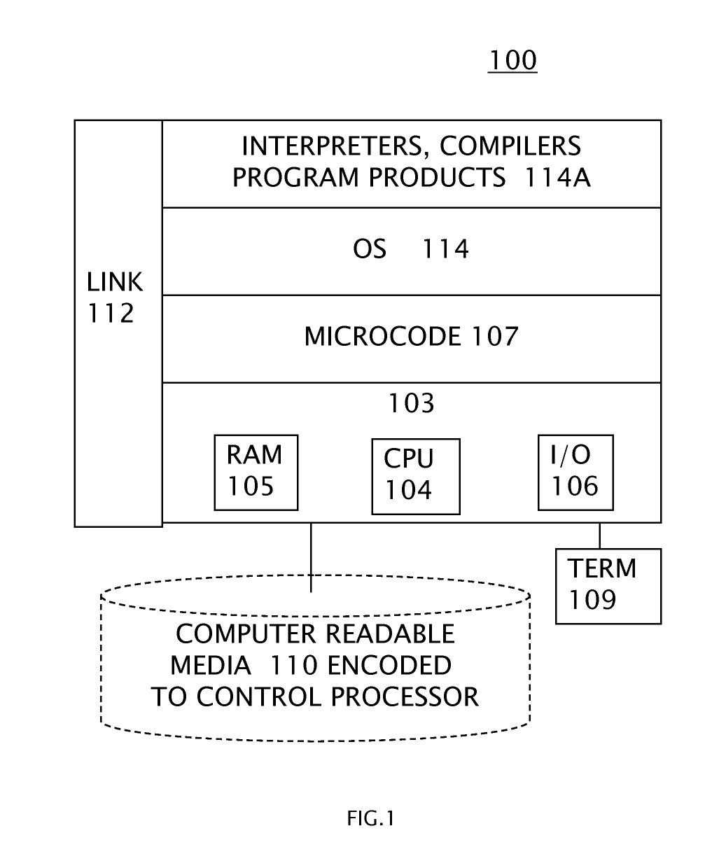

Referring now to the drawings, FIG. 1 illustrates a non-limiting exemplary conventional server known in the art comprising hardware and software configured to execute instructions and communicate to attached networks and input output devices. It is also known that a virtual machine software may present underlying hardware resources as one or more virtual processors, controlled by instructions in virtual memory, and communicating to virtual peripherals. The present invention operates on this principle and extends it in the following manner.

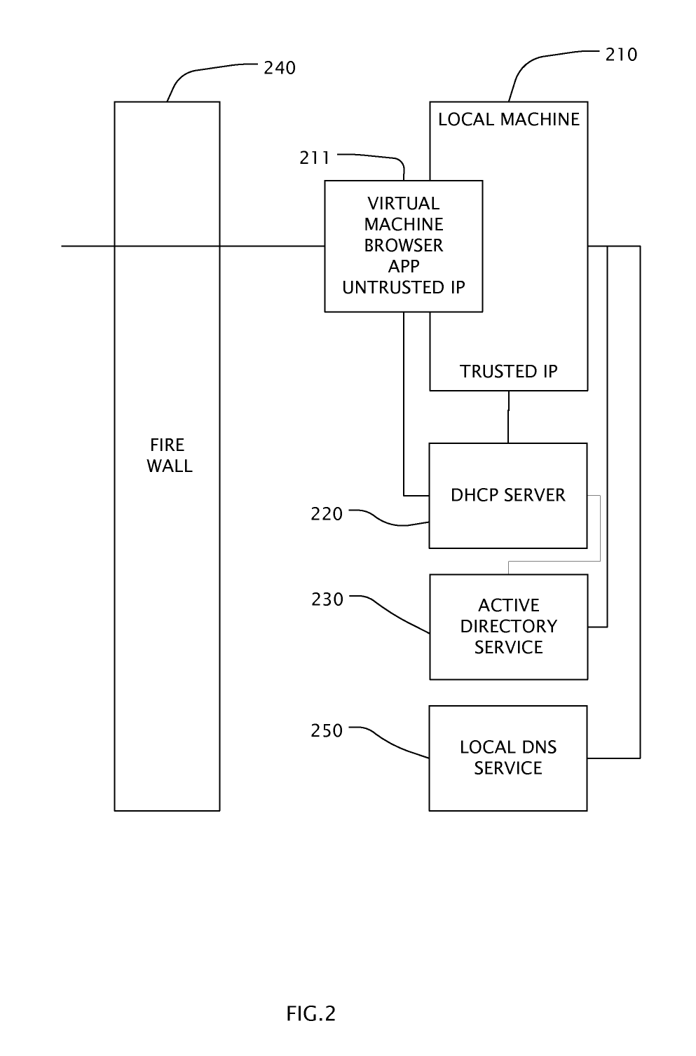

Referring now to the drawings, a system embodying the present invention is illustrated by a partial network shown in FIG. 2 wherein a local machine 210 is communicatively coupled to a dynamic host configuration protocol DHCP server 220, and further coupled to an Active Directory Service 230 because the Internet Protocol address assigned by the DHCP server 220 to the local machine is in the same network subcircuit. The Virtual Machine 211 hosted on the local machine 210 and communicatively coupled to the DHCP server is not coupled to the Active Directory Service 230 because the Internet Protocol address assigned by the DHCP server is in the Untrusted subcircuit of the network. The browser hosted by the Virtual Machine 211 is communicatively coupled to an external Internet through which it may receive malicious code which exploits a vulnerability in the browser and within the operating system of the virtual machine 211. Even though the Virtual Machine 211 may be under the control of malicious software, it cannot attack or access the Active Directory or the local DNS service because it is effectively on a different network.

In an embodiment, the Virtual Machine 211 is communicatively coupled to the external Internet through a fire wall 240. In an embodiment, a malicious software embedded in an email is disabled by the firewall while transiting from the external Internet to the Virtual Machine.

In an embodiment, the Local Machine 210 is further coupled to a local DNS service 250. In an embodiment, the local machine stores into the local DNS service a determination that a domain name is associated with an attempt to exploit a security vulnerability. In an embodiment, the Local Machine checks a local DNS service to determine if a requested resource is associated with an attempt to exploit a security vulnerability before transferring a uniform resource identifier to the browser in the virtual machine 211.

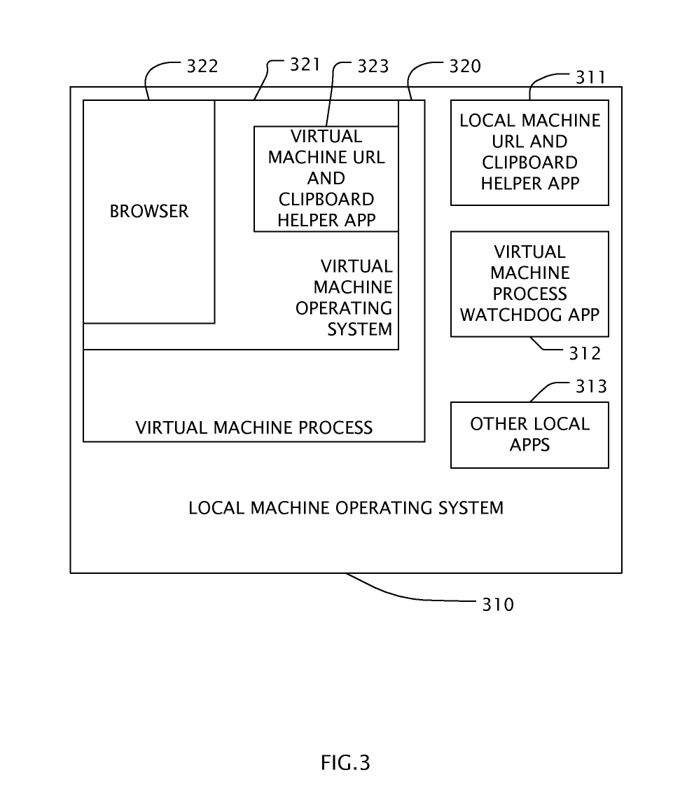

Referring now to FIG. 3, a hierarchical block diagram illustrates the processes controlling a processor in an exemplary local machine of the present invention. The lowest level of process controlling a processor is the local machine operating system 310. In addition to conventional local machine applications is a virtual machine process 320. The virtual machine process hosts a virtual machine operating system 321 controlling a processor which is an artifact of the virtual machine process. The invention comprises a browser 322 operating in conjunction with the virtual machine operating system. A security vulnerability in the browser 322 only exposes the virtual machine operating system 321 and a vulnerability in the virtual machine operating system 321 only exposes the processor provided by the virtual machine process 320 which may be wholly different from the underlying physical processor controlled by a wholly different local machine operating system 310. In a non-limiting example, the virtual machine operating system 321 may one of the many Linux or Unix open source variants while the local machine operating system may be an incompatible proprietary system. Furthermore the virtual machine process 320 may present a virtual processor that has different instructions from the actual hardware processor it is underlying. As a result, malicious code that is configured to take interfere with a specific virtual machine operating system may not execute in the instruction set of the local machine operating system.

In an embodiment, a local machine URL and clipboard helper application 311 passes text strings such as uniform resource identifiers to a corresponding helper application 323 operated by the virtual machine.

In an embodiment, a virtual machine process watchdog application 312 observes network requests within the virtual machine and terminates the virtual machine process if it detects an attempt to change privileges in the browser or in the virtual machine operating system.

In an embodiment, the local machine uniform resource identifier and clipboard helper application 311 checks for a match with a domain name system server in the trusted network for a known malicious host id.

In an embodiment, the local machine uniform resource identifier and clipboard helper application 311 checks for a match with a firewall for a known malicious host id.

### CONCLUSION

It can be easily appreciated that such a system and method for detecting and thwarting browser-based network intrusions and attacks, theft of intellectual property and loss of confidentiality is distinguished from conventional network security systems by the following characteristics:
The apparatus may be configured to prevent browser based attacks that can be used to escalate privilege for the attacker on the local machine and leverage that to gain network admin rights.
The apparatus comprises a processor configured with a stripped-down Operating System running in a Process Virtual Machine and operates a web browser on top of it. The virtual machine will run as a process on the local machine.
Configuring the virtual machine comprises identifying itself to the DHCP server so that it can be placed in the untrusted subnet while the local machine remains on the trusted local network.
Placing the VM in the untrusted network segregates it away from corporate services preventing local network privilege escalation.
Such a system is enhanced by directing the virtual machine process to special DNS servers capable of identifying known security threat sources. Such special DNS servers can be provided by the firewall, a DNS server in the untrusted network, or a remote DNS service on the Internet.
Helper applications on the local machine and VM allow transfer of URL and clipboard information between the two using simple inter-process communication.
Another application residing on the local machine monitors the virtual machine process for signs of compromise. This can also be used to categorize and identify new types of attacks. This watchdog can also note if the VM attempts to change its IP to get around network partitioning.
When unusual activity in the VM is detected VM image can be replaced with an uncompromised copy. The infected image can be used for analysis.
Unusual activity will generally be identified by non-web related network calls. Especially windows network access attempts.
Identification/classification by local machine app will be done by “finger printing” unusual network calls and checking them against a centralized database of attack fingerprints.
Unknown fingerprints are relayed to a central clearing house for identification such as provided by Barracuda Central.

What is claimed is:

1. A system comprising a layered network of trusted and untrusted subnets isolated by a firewall from the Internet wherein the trusted subnet comprises at least one DHCP Server and a plurality of local machines whose IP addresses are registered with DHCP as participating in the Active Directory and on the trusted network, the local machines configured to operate virtual machine processes communicatively coupled to the Internet by a second IP address without access to the Active Director or to the trusted network.

2. An apparatus communicatively coupled to a network comprising a trusted subnet and coupled to an untrusted subnet managed by at least one Dynamic Host Configuration Protocol (DHCP) server, comprises
a local machine configured with a first operating system and a first internet protocol address obtained from the DHCP server which is within the range of trusted sub-network IP addresses;
the local machine further configured with a virtual machine process which presents a virtual processor configured with a second operating system and a second internet protocol (IP) address assigned by the DHCP server which said IP address is within the range of un-trusted sub-network IP addresses;
the local machine further configured with a browser operating within the virtual machine process under the second operating system and communicatively coupled to the public Internet via a firewall; and
the local machine further configured with a monitoring application under the first operating system adapted to observe network activity within the virtual machine process, and terminate the virtual machine process under conditions consistent with malicious intrusion.

3. The local machine of claim 2 further configured to provide a user with access to applications and objects on the trusted sub-network, also comprises a processor configured to operate a virtual machine process configured to have no privileges within the trusted network.

4. A method for operating a processor configured with a virtual machine process comprising requesting assignment of an IP address from the DHCP server and receiving an IP address which does not have access to the Active Director Server but does have access to the external public Internet.

5. A method for operating a processor configured to operate on a trusted subnet of a network by
transferring every request for a resource on the Internet to a virtual machine configured to run an operating system and a browser, said virtual machine configured with an Internet Protocol address that is external to the trusted subnet of the network.

6. The method of claim 5 further comprising operating a monitor program to adapt the processor of the local machine to terminate the virtual machine process on detection of an attempted intrusion.

7. The method of claim 6 wherein said monitor program adapts the processor of the local machine to terminate the virtual machine process on the condition of matching the fingerprints of non-web related network calls within a file.

8. The method of claim 6 wherein said monitor program adapts the processor of the local machine to terminate the virtual machine process on the condition of attempting to exploit a vulnerability in a browser.

9. The method of claim 6 wherein said monitor program adapts the processor of the local machine to terminate the virtual machine process on the condition of attempting to exploit a vulnerability in an operating system.

10. The method of claim 6 wherein said monitor program adapts the processor of the local machine to terminate the virtual machine process on the condition of attempting to access an Active Directory service.

11. The method of claim 6 wherein said monitor program adapts the processor of the local machine to terminate the virtual machine process on the condition of attempting a network services command.

12. The method of claim 6 wherein said monitor program adapts the processor of the local machine to terminate the virtual machine process on the condition of attempting to change its IP address.

13. The method of claim 6 wherein said monitor program adapts the processor of the local machine to terminate the virtual machine process on the condition of attempting to access an IP address known to carry malicious software.

14. The method of claim 6 wherein said monitor program adapts the processor of the local machine to terminate the virtual machine process on the condition of sending a domain name service query for a uniform resource locator known for malicious software.

15. The method of claim 6 wherein said monitor program adapts the processor of the local machine to restore a version of the virtual machine process archived at a previous checkpoint.

16. The method of claim 6 wherein said monitor program adapts the processor of the local machine to archive the present virtual machine image and compute a signature for comparison with archived virtual machines known to be infected with malicious software.
